(19) United States
(12) Patent Application Publication
(10) Pub. No.: US 2013/0276300 A1
(43) Pub. Date: Oct. 24, 2013

(54) MINIATURE PIN EXTRACTING DEVICE

(71) Applicant: KOREA ASTRONOMY AND SPACE SCIENCE INSTITUTE, Daejeon (KR)

(72) Inventors: Sang Mok Cha, Daejeon (KR); In-Soo Yuk, Jeonju-si (KR); Chan Park, Daejeon (KR); Moo Young Chun, Daejeon (KR)

(73) Assignee: Korea Astronomy and Space Science Institute, Daejeon (KR)

(21) Appl. No.: 13/845,658

(22) Filed: Mar. 18, 2013

(30) Foreign Application Priority Data
Apr. 24, 2012 (KR) 10-2012-0042504

(51) Int. Cl. B23P 19/04

(52) U.S. Cl. CPC B23P 19/04
USPC 29/700

(57) ABSTRACT

Provided is a miniature pin extracting device for extracting a miniature pin inserted into a part. The miniature pin extracting device includes a coupling having a polygonal pillar shape, the coupling having a lower end coupled to the locating pin, a retainer mounted outside the coupling, and a screw part supported by the retainer, the screw part being coupled to an upper end of the coupling. Thus, a rotation force of the screw part may be converted into a vertical axial motion through the retainer to safely extract the locating pin without lateral force and rotation, thereby minimizing damage of the part.

### TECHNICAL FIELD

The present invention relates to a miniature pin extracting device, and more particularly, to a miniature pin extracting device which safely extracts miniature pins used for assembling miniature precision parts without damage of the parts.

### BACKGROUND ART

Generally, when precision optical and machine parts are assembled or installed, locating pins or dowel pins (hereinafter, the locating pin will be described as an example) are used to minimize assembly errors. Particularly, a pin hole having a precise diameter is processed in each of corresponding positions of two or more parts to be assembled with each other, and then one locating pin is inserted into the overlapping pin holes to assemble the parts. The locating pin commonly has a cylindrical shape. Also, to precisely match positions of the parts with each other, a surface and external diameter of the locating pin should be precisely and uniformly processed.

The locating pin and the pin hole are coupled to each other in a fitting manner in which the locating pin is inserted into the pin hole by giving an adequate machining tolerance to an external diameter of the locating pin and an internal diameter of the pin hole. In this case, a relative dimension between the locating pin and the pin hole may occur according to a value of the tolerance. As a result, clearance or interference between the locating pin and the pin hole may be decided to change a fitting degree.

The fitting degree may be classified into clearance fit, interference fit, and slide fit according to degrees of the clearance and interference.

The clearance fit is a method which clearance is increasingly given to between the locating pin and the pin hole, so a user can insert or separate the locating pin into or from the pin hole by using hands thereof. Thus, when parts are assembled or disassembled, it may prevent the parts from being damaged. On the other hand, the interference fit is a method which interference is increasingly given to assemble parts by pressing or hitting the locating pin or using thermal expansion and contraction. Therefore, since the parts may be damaged or permanently jointed in the process of pressing the locating pin, the interference fit may be mainly used for permanent joints or coupling of power transmission devices. In the case of the slide fit, only fine clearance or slight interference may be given to insert the locating pin by using a wooden hammer, an iron hammer, or a presser. Thus, when parts are disassembled from or assembled with each other, damage of the parts does not occur nearly.

Consequently, the more the clearance between the locating pin and the pin hole is increased, the more the interference degree therebetween is decreased to approach the state of the clearance fit. On the other hand, the more the clearance between the locating pin and the pin hole is decreased, the more the interference degree therebetween is increased to approach the state of the interference fit. Thus, as approaching the state of the clearance fit, assembly and disassembly may be easy relatively and a risk of damage of the parts may be reduced. However, since the interference degree is less, an alignment error between the parts may be increased. In case of the interference fit, although the alignment error approaches zero, it may be nearly impossible to disassemble parts when the parts are assembled once. Also, even though the parts could be disassembled from each other, serious damage of the parts may occur. In case of the slide fit, disassembly of parts is not too hard, as well as an adequate alignment error can be realized. On the other hand, manufacturing costs may be increased, because more precise processing is required to obtain desired mechanical alignment performance. Thus, as described above, since each of the three fitting methods has the pros and cons, suitable fitting design should be applied with required tolerance.

In the connection, in a developing process of precision optical/machine equipment which is being widely applied over scientific technique industries in addition to astronomical instruments and satellite fields, several experiments and processes such as correction, replacement, and precise position adjustment of modules(parts) are performed until the equipment exerts maximum performance thereof. In this process, many assembly and disassembly processes are performed, and also, an alignment state of the parts should be maintained properly. Thus, it is advantageous to design a locating pin and pin hole in the clearance fit in which the parts can be assembled or disassembled by using user's hands or the slide fit having a relatively less interference degree. Also, even though the clearance fit is applied, it is not difficult to insert a locating pin by using the user's hands, but may be difficult to extract the locating pin. In this case, a locating pin extracting device is required. The difficulty of the extraction of the locating pin is mainly due to the deformation of the parts. For example, the main reasons may be surface damage of the pin hole or deformation of the parts due to cooling, heating, or stress.

The locating pin is generally machined from stainless steel in consideration of precision, strength, and processability. Also, a part in which the pin hole is processed may be formed of various materials such as general steel or an aluminum alloy. Recently, in the manufacture of precision optical equipment, a part in which the pin hole is processed is mainly formed of an aluminum alloy in consideration of processability and weight. However, the aluminum alloy may be relatively soft and have less hardness to cause scratches when compared with the stainless steel. Thus, when the locating pin is inserted or extracted, fine scratches or deformation may occur. Particularly, when the locating pin is forcibly extracted by applying an excessive force in a case where it is difficult to smoothly extract the locating pin, the surface of the pin hole, which should be maintained in precision, may be damaged or deformed. Thus, when the parts are reassembled, it may be difficult to smoothly insert the locating pin again, as well as, the pin hole may be expanded to prevent a proper function of the locating pin from being performed. Also, as described above, when a cooling/heating cycle is repeatedly performed several times during the experiments, the parts in itself may be deformed to prevent the locating pin from being smoothly extracted. In this case, when an excessive force is applied, the pin hole may be permanently damaged. Thus, to prevent the pin hole from being damaged, when the locating pin is extracted, it may be preferable that the excessive lateral force is not applied, and friction may be minimized by maximally restricting rotation of the locating pin.

Consequently, considering the above-described circumstances, in order to minimize the assembly and alignment error between the parts, the structural design of the locating pin in itself is important, as well as the development with respect to a locating pin extracting device which can extract the locating pin without damage of the pin hole on the parts may be very important. A locating pin extracting device according to a related art will now be descried in detail with reference to the accompanying drawing.

FIG. 1 is a side sectional-view of a commercial locating pin extracting device according to a related art.

Referring to FIG. 1, a locating pin extracting device 10 according to a related art includes a shaft 11, a shaft knurling part 12 and hammer 13 which are respectively coupled to an intermediate portion and a rear end of the shaft 11, a hold cap 14 mounted on a front end of the shaft 11, and a bolt 15 inserted into the hold cap 14. An operation process of the locating pin extracting device 10 including the above-described components will be described below.

First, the bolt 15 is inserted into the hold cap 14 to couple the hold cap 14 to the front end of the shaft 11. Thereafter, the shaft knurling part 12 is rotated to mount the front end of the bolt 15 on a locating pin (not shown). Then, the hammer 13 is slid backward to extract the locating pin.

However, to use the locating pin extracting device 10 including the above-described components, a thread hole should be designed in a center of the locating pin. The commercial locating pin in which the thread hole is processed has a diameter of 4 mm or more. Here, M3 thread hole is the smallest of commercial parts. Thus, to apply the locating pin extracting device 10, the pin hole should be designed to have a size of at least 4 mm or more. However, as increased requirements for development of more compact and precision optical devices with miniature precision parts, more miniaturized locating pins are needed. If a locating pin having a diameter of about 4 mm or more is used, the parts may be increased in volume, and thus, the products may be increased in weight.

Various pin extracting tools or devices have been developed for more effectively and stably extracting the locating pin in addition the above-described device 10. However, most of the developed devices extract locating pins by batting. Thus, when the batting occurs, impacts may be applied to the locating pin and the pin hole. As a result, the locating pin may be tilted in a lateral direction, or the locating pin and the parts may be damaged.

### DISCLOSURE

[Technical Problem]

The present invention has been made in view of the above problems, it is an object of the present invention to provide a miniature pin extracting device which quickly and simply extracts a miniature pin having a diameter of about 3 mm or less without damage of parts.

[Technical Solution]

According to an aspect of the present invention, a miniature pin extracting device for extracting a locating pin inserted into a part includes: a coupling having a polygonal pillar shape, the coupling having a lower end coupled to the locating pin; a retainer mounted outside the coupling; and a screw part supported by the retainer, the screw part being coupled to an upper end of the coupling.

A hollow part having a shape corresponding to that of an outer circumference surface of the coupling may be defined inside the retainer.

A protrusion may be disposed on a lower portion of the retainer, and a concave groove part may be disposed in the part to insert the protrusion into the concave groove part.

A grasp part may be disposed outside the retainer.

At least one spacer may be disposed between the coupling and the screw part.

A protrusion may be disposed on a lower portion of the spacer, and a stepped portion may be disposed on an upper portion of the retainer to insert the protrusion into the stepped portion.

A concave part may be disposed in an upper portion of the spacer to insert the protrusion into the concave part when the spacers are stacked in multistage.

The locating pin and the coupling may be screw-coupled to each other.

The locating pin may include a body part inserted into the part and a head part having a male screw thread on an outer surface thereof and coupled to a female screw thread on the coupling.

A flange part may be disposed between the body part and the head part.

The coupling may have a square pillar shape.

The hollow part may have a square pillar shape matched with the outside shape of the coupling.

A screw thread may be defined in an inner circumference surface of the coupling.

[Advantageous Effects]

According to the present invention, since the locating pin is extracted using the coupling, which is moved vertically without being rotated by the restriction of the retainer, as a medium, a risk of damage of the part may be minimized.

Also, since the locating pin has a relatively small and simple, the locating pin may be quickly and easily extracted even in a narrow space.

### DESCRIPTION OF DRAWINGS

The above and other features and advantages of the present invention will become more apparent by describing in detail exemplary embodiments thereof with reference to the attached drawings in which:

FIG. 1 is a side sectional-view of a commercial locating pin extracting device according to a related art;

FIG. 2 is a perspective view illustrating an installed state of a miniature pin extracting device according to an embodiment of the present invention;

FIG. 3 is a perspective view illustrating an internal structure in a state where the miniature pin extracting device is installed according to an embodiment of the present invention;

FIG. 4 is a vertical sectional-view of the miniature pin extracting device according to an embodiment of the present invention;

FIG. 5 is a plan view of the miniature pin extracting device according to an embodiment of the present invention;

FIG. 6 is a vertical sectional-view of a locating pin to which the miniature pin extracting device is applied according to an embodiment of the present invention;

FIG. 7 is a view illustrating an operation process of the miniature pin extracting device according to an embodiment of the present invention; and

FIG. 8 is a view illustrating an operation process of a miniature pin extracting device according to another embodiment of the present invention.

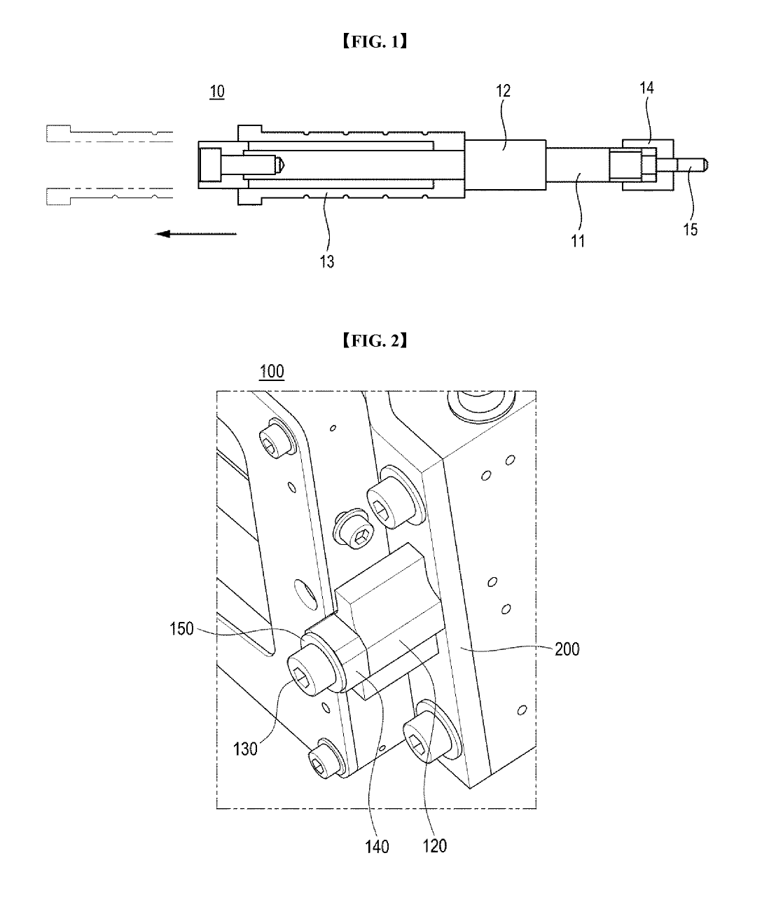

### BEST MODE

Preferred embodiments of the present invention will be described below in more detail with reference to the accompanying drawings, such that those skilled in the art can realizes the technical ideas of the inventive concept without difficulties. The present invention may, however, be embodied in different forms and should not be construed as limited to the embodiments set forth herein. In the drawings, anything unnecessary for describing the present disclosure will be omitted for clarity, and like reference numerals refer to like elements throughout.

The present invention relates to a device for extracting a locating pin inserted into precision optical and machine parts. Here, “the locating pin” that is a subject of the present invention represents a pin used for coupling two or more parts to each other. Also, although the pin is differently expressed such as a “locating pin” and a “dowel pin”, it would be understood that the above-described pins are included in the present invention. Exemplary embodiments of the present invention will be described below in more detail with reference to the accompanying drawings.

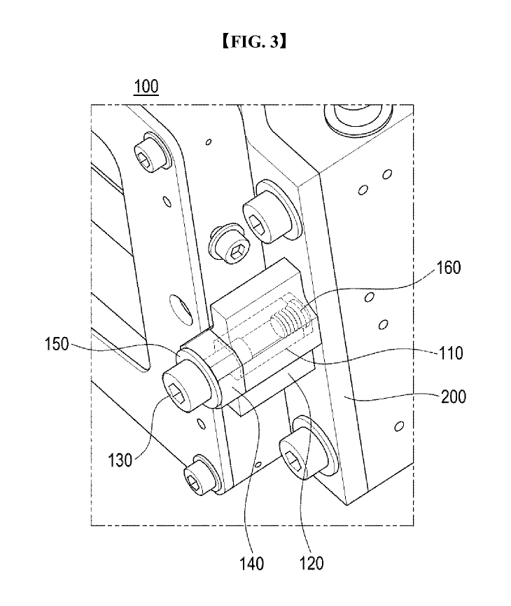

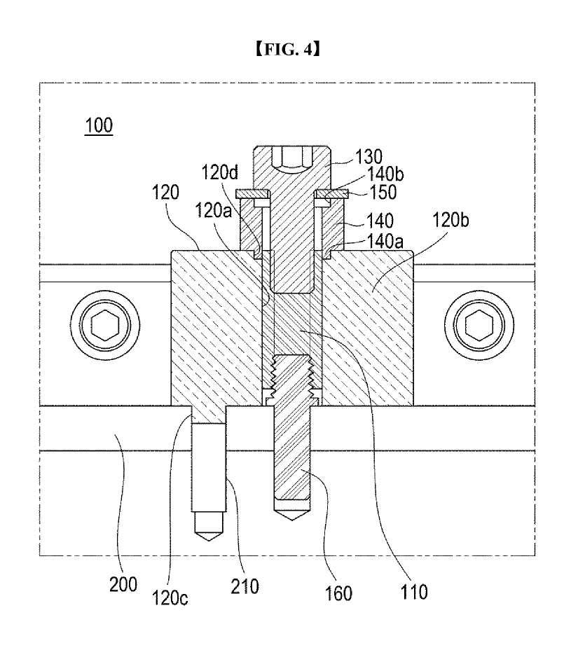

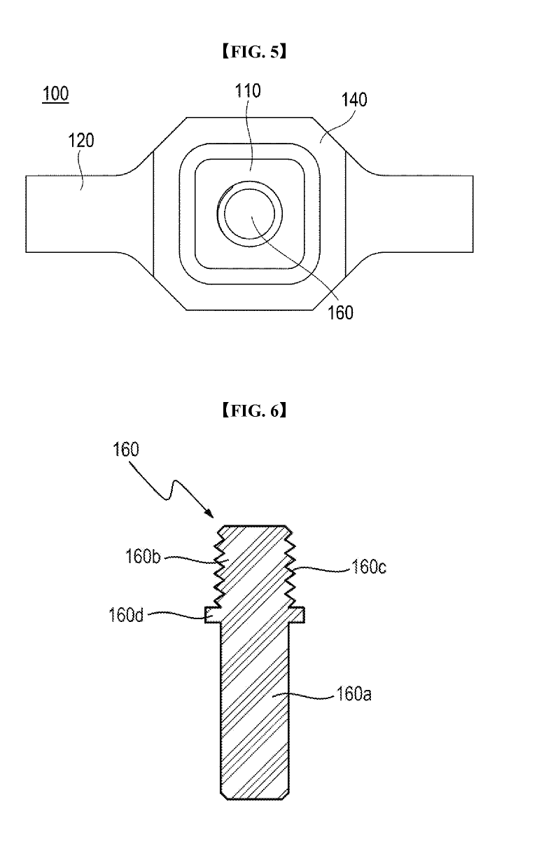

FIG. 2 is a perspective view illustrating an installed state of a miniature pin extracting device according to an embodiment of the present invention. FIG. 3 is a perspective view illustrating an internal structure in a state where the miniature pin extracting device is installed according to an embodiment of the present invention. FIG. 4 is a vertical sectional-view of the miniature pin extracting device according to an embodiment of the present invention. FIG. 5 is a plan view of the miniature pin extracting device according to an embodiment of the present invention.

Referring to FIGS. 2 to 5, a miniature pin extracting device 100 according to an embodiment of the present invention may be a device for extracting a locating pin 160 inserted into a part 200. The miniature pin extracting device 100 includes a coupling 110, a retainer 120, and a screw part 130.

The coupling 110 may serve as a medium for extracting the locating pin 160 and have a hollow polygonal pillar shape. In this case, the present invention is not limited to the shape of the coupling 110 except a cylindrical shape. For example, the coupling 110 may have various shapes such as a triangular pillar shape, a square pillar shape.

A screw thread (a female screw part) is defined in an inner circumference surface of the coupling 110 so that the locating pin 160 is coupled thereto. That is, in the present invention, the locating pin 160 is coupled to the coupling 110 with threads. For this, a screw thread (a male screw part) corresponding to the screw thread (the female screw part) is defined in a head part of the locating pin 160. Here, a specific shape of the locating pin 160 will be described below in detail.

The retainer 120 constrain the coupling 110 from rotation(with rotation of the screw part 130) and supports the screw part 130. A part 120a should be hollow in center for inserting the coupling 110. In this case, the hollow part 120a may have a polygonal pillar shape matched with the outside shape of the coupling 110 in order to prevent the rotation of coupling 110. However, if the hollow part 120a can constrain the coupling 110, the present invention is not limited to the shape of the hollow part 120a.

A grasp part 120b and a protrusion 120c may be designed on the retainer 120. Particularly, the grasp part 120b is provided for user's convenience. For example, the adequate number of grasp parts 120b may extend outside the retainer 120. The protrusion 120c prevents the retainer 120 from being rotated together with the screw part 130 when the screw part 130 is rotated. The protrusion 120c protrudes from a lower portion of the retainer 120. In this case, a concave groove 210 in which the protrusion 120c is inserted is defined in the part 200. In the current embodiment, a previously existing groove or hole in the part 200 may be used as the concave groove 210, or a groove or hole may be separately defined only for holding the protrusion 120c. The concave groove 210 is used for mounting the retainer 120 when the locating pin 160 is extracted. Also, in case of need for maintaining a continuously inserted state of the locating pin 160 in ordinary day, the concave groove 210 may serve as a bolt fixing hole for installing a fixture to prevent separation of the locating pin 160 from the part 200.

The screw part 130 is rotated to move the coupling 110 upward. The screw part 130 is coupled to an upper portion of the coupling 120 with threads. In the current embodiment of the present invention, a general standard bolt may be used as the screw part 130, or a part designed in a shape adequate for rotation and power transmission with threads may be used.

The screw part 130 may be supported by the retainer 120. As needed, a spacer 140 may be disposed between the screw part 130 and the retainer 120. Particularly, the spacer 140 may adjust a position of the screw part 130 to secure a stable supporting force if the locating pin 160 has a long length. Also, the adequate number of the spacers 140 may be stacked with each other according to a length of the locating pin 160. In this case, as shown in FIG. 4, a protrusion 140a is disposed on a lower portion of the spacer 140. Also, a stepped portion 120d is disposed on an upper portion of the retainer 120. Thus, when the protrusion 140a is inserted into the stepped portion 120d, the spacer 140 may be easily installed. Also, if a concave part 140b is defined in an upper portion of the spacer 140, when the spacers 140 are stacked in multistage, the protrusion 140a may be inserted into the concave part 140b to secure a stable supporting force. When the spacers 140 are stacked in multistage as described above, a washer 150 may be inserted between the uppermost spacer of the spacers 140 and the screw part 130 to prevent the screw part 130 from be worn.

The configuration of the miniature pin extracting device according to an embodiment of the present invention was described above. Hereinafter, a locating pin applied to the present invention will be described in detail with reference to the accompanying drawings.

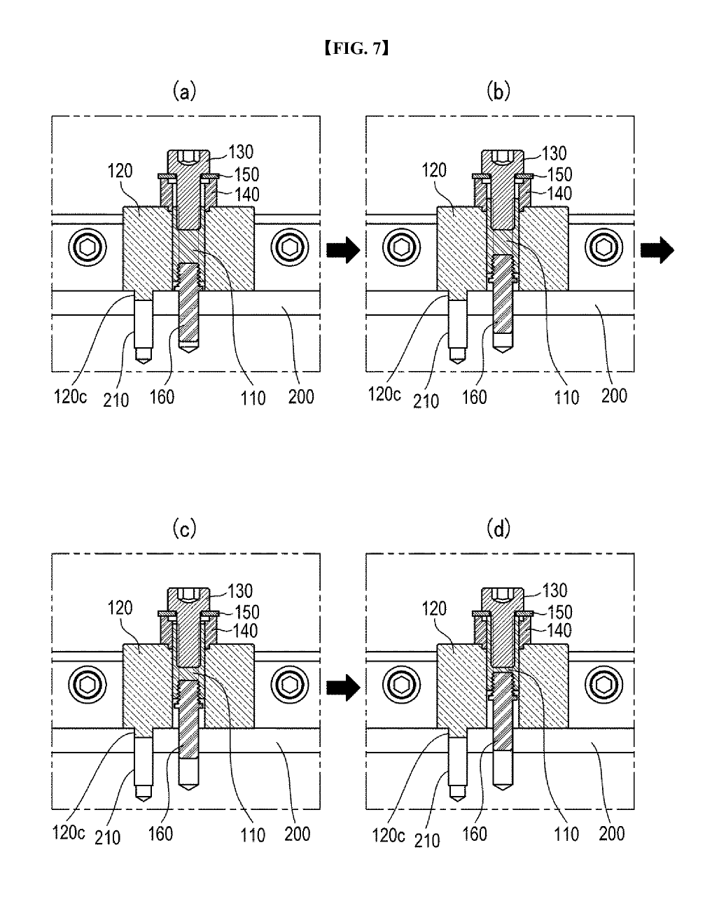

FIG. 6 is a vertical sectional-view of a locating pin to which the miniature pin extracting device is applied according to an embodiment of the present invention.

Referring to FIG. 6, the locating pin 160 includes a body part 160a inserted into the part 200 and a head part 160b extending upward from the body part 160a. A screw thread 160c is defined on an outer surface of the head part 160b.

That is, if the locating pin 160 has a small diameter, it may be difficult to process a thread hole in a center of the head part 160b, like the related art. Also, even though the screw hole is processed in the center of the head part 160b, it may be difficult to maintain a shape of the thread hole. In addition, the locating pin 160 may have weak structure due to the thread hole. Thus, when the locating pin 160 is extracted, the head part 160b may be deformed in structure, or the threads in the hole may be damaged.

According to the present invention, the screw thread 160c may be defined on the outer surface of the head part 160b in a state where the head part 160b is kept in shape with large diameter. Thus, the locating pin 160 may still have thick structure. That is, strong structure of the locating pin 160 may be secured, as well as the locating pin 160 may be easily machined. Thus, miniature locating pins easily extractable may be manufactured with a diameter of about 3 mm or less.

In this case, a flange part 160d may be disposed between the body part 160a and the head part 160b. The flange part 160d may prevent the locating pin 160 to be stuck in an end of the pin hole or totally inserted in the pin hole. Also, when parts are assembled or disassembled, the flange part 160d may be serve as a reference position. Specifically, in case of clearance fit, a user may easily extract the locating pin 160 using hands thereof through the flange part 160d.

In case of slide fit, as needed, the locating pin 160 may be inserted using a wooden hammer or an iron hammer. In this case, when the hammer hits the locating pin 160, the screw thread 160c may be damaged. Thus, an impart absorbing member such as a nut or coupling which has a thickness greater than that of the screw thread 160c may be coupled first before inserting the locating pin 160. However, in case of the clearance fit, since the locating pin may be easily inserted or extracted by user's hands, it may be unnecessary to provide the impact absorbing member.

The locating pin to which the miniature pin extracting device according to an embodiment of the present invention is applied was described above. Exemplary embodiments of the operation process using the miniature pin extracting device of the present invention will be described step by step below in more detail with reference to the accompanying drawings.

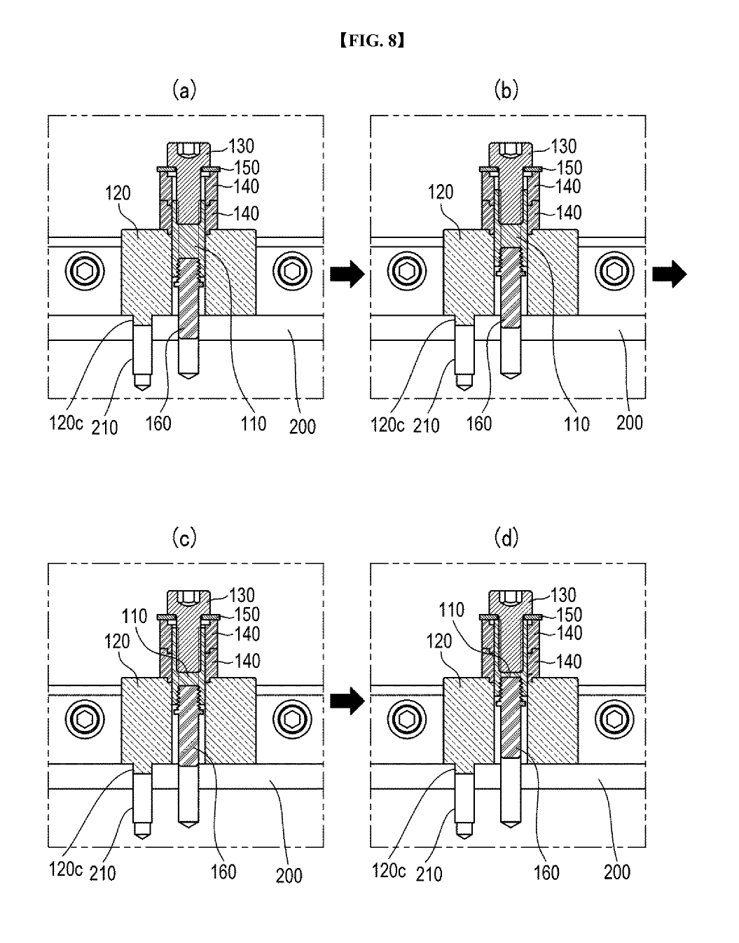

FIG. 7 is a view illustrating an operation process of the miniature pin extracting device according to an embodiment of the present invention. FIG. 8 is also a view illustrating an operation process of a miniature pin extracting device according to another embodiment of the present invention.

Referring to FIG. 7, the coupling 110 is coupled first to an upper end of the locating pin 160. Here, when the coupling 110 is coupled, the coupling 110 is not inserted up to the flange part 160d of the locating pin 160. That is, the coupling 110 may be inserted up to a portion spaced a half or one pitch of the screw thread 160c from the flange part 160d. This is done because, when the coupling 110 is coupled as described above, the locating pin 160 is not rotated, but maintained in the inserted state to prevent the part 200 from being damaged even though the coupling 110 is finely rotated.

When the coupling 110 is completely coupled, the retainer 120 is installed. In this process, the coupling 110 is inserted into a hollow part 120a of the retainer 120. Also, a bottom surface of the retainer 120 is closely attached to the part 200. As needed, the protrusion 120c may be inserted into the concave groove part 210 to prevent the retainer 120 from being rotated. In this case, each of the protrusion 120c and the concave groove part 210 may be designed to have a sufficient diameter so that the protrusion 120c is easily inserted and extracted.

After the retainer 120 is mounted, as needed, the adequate number of spacers 140 may be stacked on an upper portion of the retainer 120. Then, the washer 150 and the screw part 130 are inserted and coupled to the coupling 110 to complete the installation. When the spacer 140 is installed, the protrusion 140a is inserted into the stepped portion 120d, and the protrusion 140a of the other spacer 140 is inserted into the concave part 140b to secure a stable supporting force. In this case, a gap between the spacer 140 and the retainer 120 may be adequately designed in dimensions and manufacturing tolerance for smooth installation and extraction.

As described above, in the state where all components are installed, when the screw part 130 is rotated, the screw thread of the screw part 130 is inserted along the thread hole of the coupling 110. Thus, the coupling 110 rises up. In this case, since the coupling 110 has the polygonal pillar shape as described above and is constrained from rotating itself with inner space shape of the retainer 120. Thus, even though the screw part 130 is tightened, the screw part 130 is not rotated, but is only moved vertically due to an engagement effect between the screw threads. As described above, when the coupling 110 ascends, the locating pin 160 coupled to a lower portion of the coupling 110 may ascend at the same time and thus be separated from the part 200.

Here, in case where the locating pin 160 has a long length, since the screw part 130 is not rotated ever after the coupling 110 ascends up to the washer 150, it may be difficult to completely extract the locating pin 160. Thus, in this case, the screw part 130 is released to separate the screw part 130 from the coupling 110. Then, as shown in FIG. 8, the spacer 140 should be additionally stacked to couple the screw part 130 again to tighten the screw part 130 until the locating pin 160 is completely separated.

As described above, since the rotation force of the screw part 130 is converted into a vertical axial direction through the coupling 110 restricted by the retainer 120, any impacts are not applied to the locating pin 160 when the locating pin 160 is extracted. In addition, since the rotation force of the screw part 130 acts only in the vertical axial direction, the locating pin 160 is not rotated, and also a lateral force of the locating pin 160 does not occur. Thus, the locating pin 160 may be safely extracted without the damage of the part 200.

While the present invention has been particularly shown and described with reference to exemplary embodiments thereof, it will be understood by those of ordinary skill in the art that various changes in form and details may be made therein without departing from the spirit and scope of the present invention as defined by the following claims.

Thus, to the maximum extent allowed by law, the scope of the present invention is to be determined by the broadest permissible interpretation of the following claims and their equivalents, and shall not be restricted or limited by the foregoing detailed description.

1. A miniature pin extracting device for extracting a locating pin inserted into a part, the miniature pin extracting device comprising:
a coupling having a polygonal pillar shape, the coupling having a lower end coupled to the locating pin;
a retainer mounted outside the coupling; and
a screw part supported by the retainer, the screw part being coupled to an upper end of the coupling.

2. The miniature pin extracting device of claim 1, wherein a hollow part having a shape corresponding to that of an outer circumference surface of the coupling is defined inside the retainer.

3. The miniature pin extracting device of claim 1, wherein a protrusion is disposed on a lower portion of the retainer, and a concave groove part is disposed in the part to insert the protrusion into the concave groove part.

4. The miniature pin extracting device of claim 1, wherein a grasp part is disposed outside the retainer.

5. The miniature pin extracting device of claim 1, wherein at least one spacer is disposed between the coupling and the screw part.

6. The miniature pin extracting device of claim 5, wherein a protrusion is disposed on a lower portion of the spacer, and a stepped portion is disposed on an upper portion of the retainer to insert the protrusion into the stepped portion.

7. The miniature pin extracting device of claim 6, wherein a concave part is disposed in an upper portion of the spacer to insert the protrusion into the concave part when the spacers are stacked in multistage.

8. The miniature pin extracting device of claim 1, wherein the locating pin and the coupling are screw-coupled to each other.

9. The miniature pin extracting device of claim 8, wherein the locating pin comprises a body part inserted into the part and a head part having a male screw thread on an outer surface thereof and coupled to a female screw thread on the coupling.

10. The miniature pin extracting device of claim 9, wherein a flange part is disposed between the body part and the head part.

11. The miniature pin extracting device of claim 2, wherein the coupling has a square pillar shape.

12. The miniature pin extracting device of claim 11, the hollow part has a square pillar shape matched with the outside shape of the coupling.

13. The miniature pin extracting device of claim 8, a screw thread is defined in an inner circumference surface of the coupling.
